(19) United States
(12) Patent Application Publication
(10) Pub. No.: US 2010/0207734 A1
(43) Pub. Date: Aug. 19, 2010

(54) Information Interactive Kit and Information Interactive System Using the Same

(75) Inventor: Jung-Chi Lai, Guishan Township (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: DARFON ELECTRONICS CORP., Gueishan Hsiang (TW)

(21) Appl. No.: 12/703,327

(22) Filed: Feb. 10, 2010

(30) Foreign Application Priority Data
Feb. 18, 2009 (TW) 98202355

(51) Int. Cl. H04Q 5/22; G10L 21/00; G06F 17/30

(52) U.S. Cl. 340/10.1; 704/272; 707/802; 704/E21.001; 707/E17.044; 707/E17.005

(57) ABSTRACT

An information interactive kit adapted to an information interactive device is provided. The information interactive device is for generating an interactive event to express the content of at least one predetermined information accordingly. The information interactive kit includes a storing unit and a communicating interface. The storing unit is for storing a theme database. The communicating interface, when connected to the information interactive device, transmits the content of the theme database to the information interactive device, so that the information interactive device determines how to change the generated interactive event according to the content of the theme database.

This application claims the benefit of Taiwan application Serial No. 98202355, filed Feb. 18, 2009, the subject matter of which is incorporated herein by reference.

### BACKGROUND

1. Technical Field

The invention relates in general to an information interactive kit and an information interactive system using the same, and more particularly to an information interactive kit capable of changing an interactive event and an information interactive system using the same.

2. Background

Electronic devices have various applications. One popular electronic device is an information interactive device capable of interacting with the user.

For example, the electronic pet is an information interactive device capable of interacting with the user. When using such information interactive device, if the user sends a particular instruction to the electronic pet, the electronic pet will respond accordingly. Thus, the user can interact with the electronic pet as if the user were interacting with a real pet and is thus entertained during the interactive process.

However, when the user interacts with the electronic pet, the electronic pet just generates a corresponding interactive behavior according to its in-built database in response to the user's instruction. As such electronic pet can only interact with the user according to its in-built database, the interactions are limited.

### BRIEF SUMMARY

Embodiments of the invention are directed to an information interactive kit and an information interactive system using the same. In an embodiment of the invention, the information interactive device generates different interactive event associated with different theme databases by different ways of implementation, so as to increase the diversity of the information interactive device in generating interactive events. In another embodiment, the interactive sense in interacting with the user is effectively increased.

According to a first possible embodiment of the present invention, an information interactive kit adapted to an information interactive device is provided. The information interactive device is for generating an interactive event to express the content of at least one predetermined information accordingly. The information interactive kit includes a storing unit and a communicating interface. The storing unit is for storing a theme database. The communicating interface, when connected to the information interactive device, transmits the content of the theme database to the information interactive device, so that the information interactive device determines how to change the generated interactive event according to the content of the theme database.

According to a second possible embodiment of the present invention, an information interactive system is provided. The information interactive system includes an information interactive device and an information interactive kit. The information interactive device includes an input unit, an output unit and a processing unit. The input unit is for receiving a request signal. The processing unit obtains at least one predetermined information from at least one predetermined website within a predetermined time via an internet. The processing unit further performs data analysis to the content of at least one predetermined information in response to the request signal, and controls the output unit to generate an interactive event according to the result of analysis to express the content of at least one predetermined information accordingly. The information interactive kit includes a storing unit and a communicating interface. The storing unit is for storing a theme database. The communicating interface, when connected to the information interactive device, transmits the content of the theme database the information interactive device. The information interactive device further determines how to change the generated interactive event according to the content of the theme database.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 shows a block diagram of an information interactive kit and an information interactive device according to an embodiment of the invention;

FIG. 2 shows a block diagram of an example of an information interactive system according to the embodiment of the invention;

FIG. 3A shows an example of the information interactive device of FIG. 2;

FIG. 3B shows an example in which the processing unit controls a speaker to emit a voice Vo1 and a display to display an image Im1 before the information interactive device of FIG. 3A is connected to the information interactive kit;

FIG. 3C shows another example in which the processing unit controls the speaker to emit to a voice Vo2 instead of emitting the voice Vo1 and controls the display to display an image Im2 instead of displaying the image Im1 according to the content of the theme database after the information interactive device is connected to the information interactive kit.

### DETAILED DESCRIPTION OF EXEMPLARY EMBODIMENT OF THE INVENTION

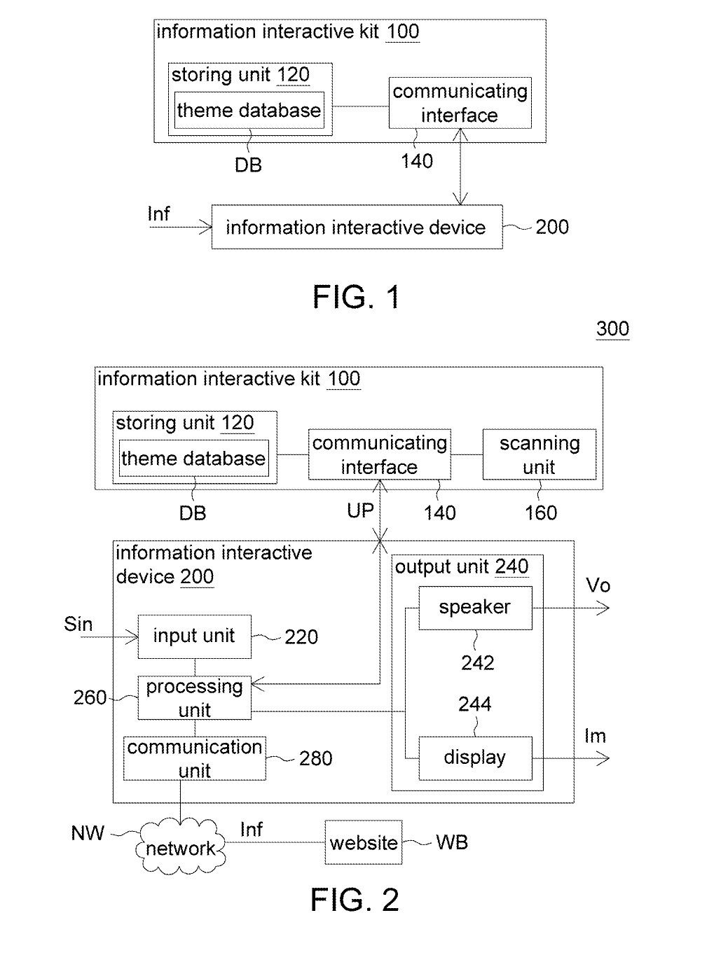

Referring to FIG. 1, a block diagram of an information interactive kit 100 and an information interactive device 200 according to an embodiment of the invention is shown. The information interactive kit 100 is suitable to the information interactive device 200. The information interactive device 200 is for generating an interactive event to express the content of at least one predetermined information Inf accordingly.

The information interactive kit 100 includes a storing unit 120 and a communicating interface 140. The storing unit 120 is for storing a theme database DB. The communicating interface 140, when connected to the information interactive device 200, transmits the content of the theme database DB to the information interactive device 200, so that the information interactive device 200 determines how to change the generated interactive event according to the content of the theme database DB.

Referring to FIG. 2, a block diagram of an example of an information interactive system 300 according to the embodiment of the invention is shown. The information interactive system 300 includes the information interactive kit 100 and the information interactive device 200 of FIG. 1. The information interactive system 300 is exemplified below for elaborating the invention.

Referring to FIG. 2. The information interactive device 200 at least includes an input unit 220, an output unit 240 and a processing unit 260. The input unit 220 is for receiving a request signal Sin. The processing unit 260 obtains at least one predetermined information Inf from at least one predetermined website WB via an internet NW within a predetermined time. The processing unit 260, in response to the request signal Sin, further analyzes the content of at least one predetermined information Inf and, according to the analysis result, controls the output unit 240 to generate an interactive event to express the content of at least one predetermined information Inf accordingly.

The output unit 240 may include at least one of a speaker 242 and a display 244. When the processing unit 260 controls the output unit 240 to generate an interactive event, the processing unit 260 controls the speaker 242 to emit a voice Vo or/and controls the display 244 to display an image Im.

The communicating interface 140 of the information interactive kit 100 may but not limitedly include at least one of an RS-232 interface, a universal serial bus (USB) interface, and a wireless fidelity (Wi-Fi) interface. The communicating interface 140, when connected to the information interactive device 200, transmits the content of the theme database DB to the information interactive device 200, and the information interactive device 200 further determines how to change the generated interactive event according to the content of the theme database DB.

In one possible example, when the information interactive device 200 changes the generated interactive event according to the content of the theme database DB, the processing unit 260 controls to change the voice Vo emitted by the speaker 242 according to the content of the theme database DB.

In another possible example, when the information interactive device 200 changes the generated interactive event according to the content of the theme database DB, the processing unit 260 controls to change the image Im displayed on the display 244 according to the content of the theme database DB.

In yet another possible example, when the information interactive device 200 changes the generated interactive event according to the content of the theme database DB, the processing unit 260 controls to change the voice Vo emitted by the speaker 242 and to change the image Im displayed on the display 244 according to the content of the theme database DB.

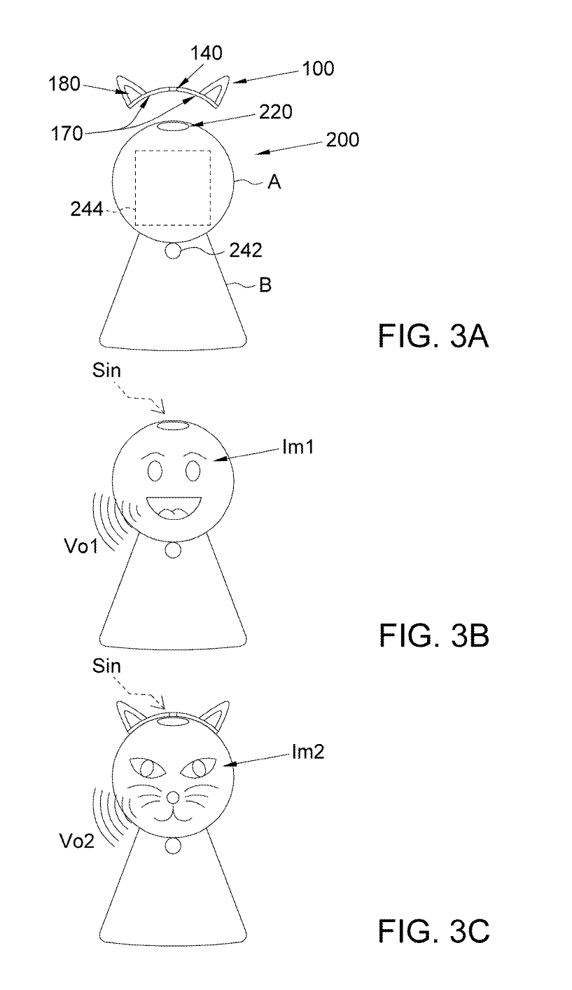

Referring to FIG. 3A˜3C. FIG. 3A shows an example of the shape of the information interactive device 200 of FIG. 2. FIG. 3B shows an example in which the processing unit 260 controls the speaker 242 to emit a voice Vo1 and controls the display 244 to display an image Im1 before the information interactive device 200 of FIG. 3A is connected to the information interactive kit 100. FIG. 3C shows another example in which the processing unit 260 controls the speaker to emit to a voice Vo2 instead of emitting the voice Vo1 and controls the display to display an image Im2 instead of displaying the image Im1 according to the content of the theme database DB after the information interactive device 200 is connected to the information interactive kit.

In the example illustrated in FIG. 3A, the shape of the information interactive device 200 includes a head A and a supporting portion B and the display 244 is disposed on the head A of the information interactive device 200. As indicated in FIGS. 3B and 3C, after the information interactive device 200 is connected to the information interactive kit 100, the voice Vo1 and the image Im1 originally emitted by and displayed by the information interactive device 200 will be respectively changed into a voice Vo2 and an image Im2 according to the content of the theme database DB.

Thus, the design of different contents of the theme database DB enables the information interactive device 200 to change the voice and the image provided thereby so as to change the interactive event generated by the information interactive device 200. When the user uses the information interactive kit storing different theme databases, the information interactive device 200 will change the generated interactive event in different patterns so as to increase the diversity of the information interactive device in generating interactive event.

Furthermore, in changing the voice Vo emitted by the speaker 242, the processing unit 260 changes the vocal expression of the voice Vo emitted by the speaker 242, wherein the vocal expression such as includes at least one of voice speed, voice tone, voice strength, and voice frequency. As indicated in FIGS. 3B and 3C, the voices Vo1 and Vo2 have different vocal expressions.

As indicated in FIG. 3A, in changing the image Im displayed by the display 244, the processing unit 260 changes the facial expression of the image Im displayed by the display 244 disposed on the head A, wherein the facial expression such as includes at least one of facial shape and facial sign. As indicated in FIGS. 3B and 3C, the image Im1 and the image Im2 have different facial expressions.

Thus, by changing the vocal expression of the voice Vo emitted by the speaker 242 or/and the facial expression of the image Im displayed by the display 244, the user can feel the emotions (such as happiness, anger, sadness and joy) implicit in the information interactive device 200 so that the interactive sense is further improved.

Referring to FIG. 2. The information interactive device 200 may further include a communication unit 280 for connecting the processing unit 260 to a computer (not illustrated) and an internet NW. The processing unit 260, when connected to the computer, receives a setting value related to the operation of the information interactive device 200 from the computer. For example, according to the received setting values, the information interactive device 200 determines how to control the output unit 240 to generate a corresponding interactive event, or determines how to control the communication unit 280 (such as: when, where and how to obtain the predetermined information Inf, or determines to obtain which predetermined information Inf from which website WB).

In another possible embodiment, the theme database DB stored in the storing unit 120 may include the setting values related to the operation of the information interactive device 200. Thus, in the embodiment, the user does not need to manually provide the setting value to the information interactive device 200 through the computer. Instead, the information interactive device 200 can automatically receive the setting values of the theme database DB and hence achieving automatic setting.

Moreover, when the information interactive device 200 changes the interactive event according to the content of the theme database DB, the information interactive device 200 determines how to generate an interactive event according to the received setting value.

For example, the information interactive device 200 may actively or periodically generate an interactive event according to the setting values. Let the interactive event in which the speaker 242 is controlled to emit a voice Vo be taken for example. After receiving the setting values, the information interactive device 200 actively or periodically performs data analysis on the predetermined information Inf which may regard tourism, gourmet, or medicare and health; and controls the speaker 242 to emit the voice Vo according to the analysis result so as to provide related information to the user. In other words, the information interactive device 200 may actively or periodically provide the user with the information regarding the best tourist resorts for the current season or recommended gourmet, or provides the user with medicare and health information such as the recent onsets of flu or infectious diseases. Thus, during the interactive process between the user and the information interactive device 200, the user is able to sense the implicit features (such as favorite of tourism or gourmet) of the information interactive device 200 according to the interactive event (such as the event of providing information regarding tourism or gourmet) generated by the information interactive device 200 actively or periodically so as to improve the interactive sense.

Moreover, the communicating interface 140 of the information interactive kit 100 further receives an update data UP from the information interactive device 200 to update the theme database DB stored in the storing unit 120. Examples of the update data UP include the data obtained by algorithm during the interactive process between the information interactive device 200 and the user, wherein the update data denotes the user's use features (such as the natures and the occasions of the user's most common inquiries). Thus, by updating the theme database DB by the update data UP, an interactive event may be generated according to the updated theme database DB when the information interactive kit 100 is connected to another the information interactive device.

Referring to FIG. 2. The information interactive kit 100 may include a scanning unit 160 for scanning a tag. The communicating interface 140 further transmits the content of the tag to the information interactive device 200 and the information interactive device 200 further generates a corresponding interactive event according to the content of the tag. In practical application, the scanning unit 160 is such as a radio frequency identification (RFID) scanner, and the tag is such as an RFID tag. After the information interactive device 200 is connected to the information interactive kit 100, the information interactive device 200 obtains the content of the tag through the scanning function of the scanning unit 160 of the information interactive kit 100 so as to generate a corresponding interactive event.

The above disclosure is exemplified by the scanning unit 160, but the invention is not limited thereto. In other embodiments, the information interactive kit 100 may also include circuits having other functions (such as camera or another speaker with features other than that of the speaker 240), so that the information interactive device 200, after connected to the information interactive kit 100, generates a corresponding interactive event by the additional circuit functions of the information interactive kit 100.

Referring to FIG. 3A. For the information interactive kit 100 to be physically and electrically connected to the information interactive device 200, the information interactive kit 100 further includes at least one fixing member 170 for fixing the information interactive kit 100 on the information interactive device 200. The fixing member 170 includes a magnet, an engaging structure and a sucking disc. Thus, the fixing member 170 can fix the information interactive kit 100 on the information interactive device 200 by at least one way of magnetism, engagement and sucking. Thus, when the information interactive kit 100 is connected to the information interactive device 200, the information interactive kit 100 and the information interactive device 200 are electrically and mechanically connected together via the communicating interface 140 and the fixing member 170.

For the sake of aesthetics, in the example of FIG. 3A, the shape of the information interactive kit 100 is such as a head ornament for mounting on the head of the information interactive kit 100, and the fixing member 170 is disposed at where the head ornament contacts the head A. Thus, the information interactive kit 100 decorates the information interactive device 200.

Referring to FIG. 3A˜3C. Assuming the theme database DB stored in the information interactive kit 100 corresponds to a certain character (such as a kitty). Meanwhile, the information interactive kit 100 will be designed to have the shape of a kitty's ear (as indicated in FIG. 3A) and the theme database DB is corresponding to the kitty. In FIG. 3C, after the information interactive kit 100 and the information interactive device 200 are connected together, not only will the connection shape look like a kitty but also the image Im2 displayed and voice Vo1 generated by the information interactive device 200 have kitty-like attributes. Or, the information interactive kit 100 can also control the information interactive device 200 to implicitly carry the kitty's emotions or features (such as meek or playful) when showing the predetermined information Inf. Thus, the information interactive kit 100 of the present embodiment of the invention enables the information interactive device 200 to have entertainment effect of role playing and further improve the interactive sense.

In other embodiments, the information interactive kit may further include a light emitter 180 controlled by the information interactive device 200 to emit a light. Thus, the information interactive kit can be used as a head ornament (or other ornaments or accessories) more decorative.

According to the information interactive kit and the information interactive method thereof disclosed in the embodiment of the invention, when the information interactive kit is connected to the information interactive device, the content of the theme database inside the information interactive kit is transmitted to the information interactive device, so that the information interactive device determines how to change the generated interactive event according to the content of the theme database. The above embodiment of the invention have many advantages exemplified below:

(1) In an embodiment, the information interactive kit controls the information interactive device to generate an interactive event corresponding to different theme databases in different patterns, so as to increase the diversity of the information interactive device in generating interactive events.

(2) In another embodiment, the information interactive kit controls the information interactive device to change the vocal expression of the voice emitted by the speaker or the facial expression of the image displayed on the display, so as to increase the interactive sense.

(3) In another embodiment, the information interactive kit controls the information interactive device to actively or periodically generate interactive events, so as to increase the interactive sense.

(4) In some embodiments, the shape of the information interactive kit or lighting effect from the information interactive kit can decorate the information interactive device.

(5) In another embodiment, the information interactive kit enables the shape of the information interactive device or the image displayed on the information interactive device matches the role defined by theme database so as to provide entertainment effect and increase the interactive sense.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. An information interactive kit adapted to an information interactive device, the information interactive device generating an interactive event to express a content of at least one predetermined information accordingly, the information interactive kit comprising:
a storing unit for storing a theme database; and
a communicating interface for transmitting a content of the theme database to the information interactive device when connected to the information interactive device, so that the information interactive device determines how to change the generated interactive event according to the content of the theme database.

2. The information interactive kit according to claim 1, wherein the communicating interface further receives an update data from the information interactive device to update the theme database stored in the storing unit.

3. The information interactive kit according to claim 1, further comprising:
a scanning unit for scanning a tag;
wherein the communicating interface further transmits a content of the tag to the information interactive device, so that the information interactive device accordingly generates the interactive event according to the content of the tag.

4. The information interactive kit according to claim 3, wherein the scanning unit is a radio frequency identification (RFID) scanner and the tag is an RFID tag.

5. The information interactive kit according to claim 1, wherein the theme database stored in the storing unit comprises a setting value related to operations of the information interactive device.

6. The information interactive kit according to claim 1, further comprising:
at least one fixing member for fixing the information interactive kit on the information interactive device.

7. The information interactive kit according to claim 6, wherein the at least one fixing member fixes the information interactive kit on the information interactive device by at least one of magnetism, engagement and sucking or any combination thereof.

8. The information interactive kit according to claim 6, wherein the at least one fixing member comprises at least one of a magnet, an engaging structure and a sucking disc or any combination thereof.

9. The information interactive kit according to claim 6, wherein a shape of the information interactive device comprises a head and a supporting portion, a shape of the information interactive kit is a head ornament mounted on the head of the information interactive device, and the at least one fixing member is disposed at where the head ornament contacts the head.

10. The information interactive kit according to claim 1, further comprising:
a light emitter controlled by the information interactive device to emit a light.

11. The information interactive kit according to claim 1, wherein the communicating interface comprises at least one of an RS-232 interface, a universal serial bus (USB) interface and a wireless fidelity (Wi-Fi) interface or any combination thereof.

12. The information interactive kit according to claim 1, wherein the information interactive device obtains the at least one predetermined information from at least one predetermined website via an internet within a predetermined time, and the information interactive device further performs data analysis on the content of at least one predetermined information and generates the interactive event according to the result of analysis to express the content of at least one predetermined information accordingly.

13. An information interactive system, comprising:
an information interactive device, comprising:
an input unit for receiving a request signal;
an output unit; and
a processing unit for obtaining at least one predetermined information from at least one predetermined website via an internet within a predetermined time, wherein the processing unit, in response to the request signal, performs data analysis on the at least one predetermined information, and controls the output unit to generate an interactive event according to the result of analysis to express a content of at least one predetermined information accordingly; and
an information interactive kit, comprising:
a storing unit for storing a theme database; and
a communicating interface for transmitting a content of the theme database to the information interactive device when connected to the information interactive device;
wherein the information interactive device further determines how to change the generated interactive event according to the content of the theme database.

14. The information interactive system according to claim 13, wherein the communicating interface of the information interactive kit further receives an update data from the information interactive device to update the theme database stored in the storing unit.

15. The information interactive system according to claim 13, wherein the information interactive kit further comprises:
a scanning unit for scanning a tag;
wherein the communicating interface further transmits a content of the tag to the information interactive device, and the information interactive device further generates a corresponding interactive event according to the content of the tag.

16. The information interactive system according to claim 15, wherein the scanning unit is a radio frequency identification (RFID) scanner, and the tag is a RFID tag.

17. The information interactive system according to claim 13, wherein
the theme database stored in the storing unit comprises a setting value related to operations of the information interactive device; and
wherein the information interactive device further determines how to generate the interactive event according to the setting value.

18. The information interactive system according to claim 17, wherein when the information interactive device changes the interactive event according to the content of the theme database, the information interactive device actively or periodically generates the interactive event according to the setting value.

19. The information interactive system according to claim 13, wherein the information interactive kit further comprises:
at least one fixing member for fixing the information interactive kit on the information interactive device.

20. The information interactive system according to claim 19, wherein the at least one fixing member fixes the information interactive kit on the information interactive device by at least one of magnetism, engagement and sucking or any combination thereof.

21. The information interactive system according to claim 19, wherein the at least one fixing member comprises a magnet, an engaging structure and a sucking disc or any combination thereof.

22. The information interactive system according to claim 19, wherein a shape of the information interactive device comprises a head and a supporting portion, a shape of the information interactive kit is a head ornament mounted on the head of the interactive device, and the at least one fixing member is disposed at where the head ornament contacts the head.

23. The information interactive system according to claim 13, wherein the information interactive kit further comprises:
a light emitter controlled by the information interactive device to emit a light.

24. The information interactive system according to claim 13, wherein the communicating interface comprises at least one of an RS-232 interface, a universal serial bus (USB) interface and a wireless fidelity (Wi-Fi) interface or any combination thereof.

25. The information interactive system according to claim 13, wherein the output unit comprises a speaker, and the processing unit controls the speaker to emit a voice when the output unit generates the interactive event.

26. The information interactive system according to claim 25, wherein when the information interactive device changes the interactive event according to the content of the theme database, the processing unit changes the voice emitted by the speaker according to the content of the theme database.

27. The information interactive system according to claim 26, the processing unit changes the vocal expression of the voice emitted by the speaker, and the vocal expression comprises at least one of voice speed, voice tone, voice strength, and voice frequency or any combination thereof.

28. The information interactive system according to claim 13, wherein the output unit comprises a display, and the processing unit controls the display to display an image when the output unit generates the interactive event.

29. The information interactive system according to claim 28, wherein when the information interactive device changes the interactive event according to the content of the theme database, the processing unit changes the image displayed on the display according to the content of the theme database.

30. The information interactive system according to claim 29, wherein the shape of the information interactive device comprises a head and a supporting portion, and the display is disposed on the head of the information interactive device;
wherein the processing unit changes the facial expression of the image displayed, and the facial expression comprises at least one of facial shape and facial sign or any combination thereof.
